(19) United States
(12) Patent Application Publication
(10) Pub. No.: US 2015/0117962 A1
(43) Pub. Date: Apr. 30, 2015

(54) RESIN SYSTEM AND ROCK ANCHOR

(71) Applicants: Andrew Sykes, Nowra (AU); Robert Hawker, Nowra (AU)

(72) Inventors: Andrew Sykes, Nowra (AU); Robert Hawker, Nowra (AU)

(73) Assignee: MINOVA INTERNATIONAL LIMITED, Chesterfield Derbyshire (GB)

(21) Appl. No.: 13/812,379

(22) PCT Filed: Jul. 26, 2011
(86) PCT No.: PCT/GB2011/051423

§ 371 Date: May 29, 2013

(30) Foreign Application Priority Data
Jul. 29, 2010 (AU) 2010100811

(51) Int. Cl. E21D 21/00; C08G 18/02; E21D 20/02

(52) U.S. Cl. CPC E21D 21/008; E21D 20/025; C08G 18/02; E21D 2021/0053
USPC 405/259.5

(57) ABSTRACT

The invention provides kit comprising a rock anchor (20) having a static mixer (60) and a two part resin system (80,90) wherein a first part (80) of the resin system comprises an isocyanate and a second part (90) of the resin system comprises a silicate; a rock anchor secured in a ground formation (140); and a method of securing a rock anchor.

The present invention relates to a system comprising a rock anchor which may be self-drilling and a resin system for use in securing the rock anchor, especially to a two part resin system comprising a silicate part and an isocyanate or isocyanate/pre polymer part, and to methods of using the resin system with a rock anchor.

Rock anchors are used in mining and in civil engineering to support soil or rock formations to secure a steep bank or a mine/tunnel roof/walls/floors. Rock anchors are usually anchored in place using a grout system which is cement-based or polymer-based. The rock anchor may have a channel through which the grout system is pumped until the hole and the channel are filled. It is difficult to find a grout system which is pumpable for a sufficient time but then cures quickly enough and with a sufficiently strong early cure strength for the rock anchor to be effective without additional early support.

The resin system must also have certain properties that permit its use in underground coal mines using bulk or semi bulk supply as opposed to capsules. Some of these properties include high flash point for individual components (greater than 38 degrees C.), low flammability and high oxygen index for cured resins.

A way of ameliorating these problems has been sought.

According to the invention there is provided a system comprising a rock anchor having a static mixer and a two part resin system wherein a first part of the resin system comprises an isocyanate pre-polymer and a second part of the resin system comprises a silicate.

Advantages of using a two part resin system comprising an isocyanate pre-polymer and a silicate include that it has an early cure strength sufficient to retain a rock anchor in a drilled hole without additional support. It also has a high flash point, low flammability and a high oxygen index. Also, the supply pipes and pump used for the second part of the resin system may be cleaned using water as silicate is water soluble.

According to the invention there is also provided a rock anchor secured in a ground formation by a resin system which comprises an isocyanate and a silicate; wherein the rock anchor comprises a static mixer.

According to the invention there is further provided a method of securing a rock anchor in a hole drilled by the same rock anchor in a ground formation which method comprises the steps of:
providing a rock anchor having an internal channel for drill water flushing and in which is mounted a static mixer;
using the rock anchor as a self drilling bolt to form a drilled hole; and
injecting a two part resin system through the internal channel of the rock anchor and into the drilled hole so that the static mixer mixes the two part resin system so that the two part resin system cures in the drilled hole and internal channel such that the rock anchor is secured in the drilled hole; wherein a first part of the resin system comprises an isocyanate and a second part of the resin system comprises a silicate.

According to the invention there is also provided a secured tunnel in a ground formation whereby the tunnel is secured by one or more rock anchors by a resin system which comprises an isocyanate and a silicate; wherein the rock anchor comprises a static mixer.

In some embodiments, the two part resin system may be the two component silicate resin system sold by Minova Australia Pty Ltd under the trade mark “CARBOTHIX”. Advantages of using Carbothix® include that:
it is in a ratio of one part silicate to two parts isocyanate pre polymer which makes pumping and maintaining the ratio easier (but maybe used at alternative ratios between 1:1 and 1:3);
it does not include a particulate filler such that there are no particles to jam in a pump or other pathways used to inject the resin system;
it has a low viscosity (approximately 200-400 cps) such that it is easy to pump;
elimination of cold storage of polyester resin to extend shelf life; and
variable injection quantity to ensure full encapsulation of rock bolt.

In some embodiments, the static mixer has at least 10 elements. For example, the static mixer may have from 10 to 48 elements; particularly about 30 elements. Where the resin system is Carbothix®, such a large number of elements is required to provide high energy mixing. Incomplete mixing of Carbothix® can easily be detected because the resin foams on curing.

In some embodiments, the rock anchor may be further secured by a mesh netting.

In some embodiments, the rock anchor may be a self drilling bolt. A self drilling bolt is known to be easier to use than conventional rock anchors. This is because to use a conventional rock anchor, additional steps are required which include using a separate drill rig to drill the hole for the rock anchor, removing the drill rig from the hole and inserting the rock anchor into the hole. A suitable self drilling bolt is described in Peter Gray's patent application WO 2007/059580, the contents of which document are incorporated herein by reference in their entirety.

The term “ground formation” refers to a mass of rock, earth and/or soil such as may be found in an embankment, quarry, mine or tunnel.

The invention will now be illustrated with reference to the following Figures of the accompanying drawings which are provided to illustrate the invention claimed and are not intended to limit the scope of protection:

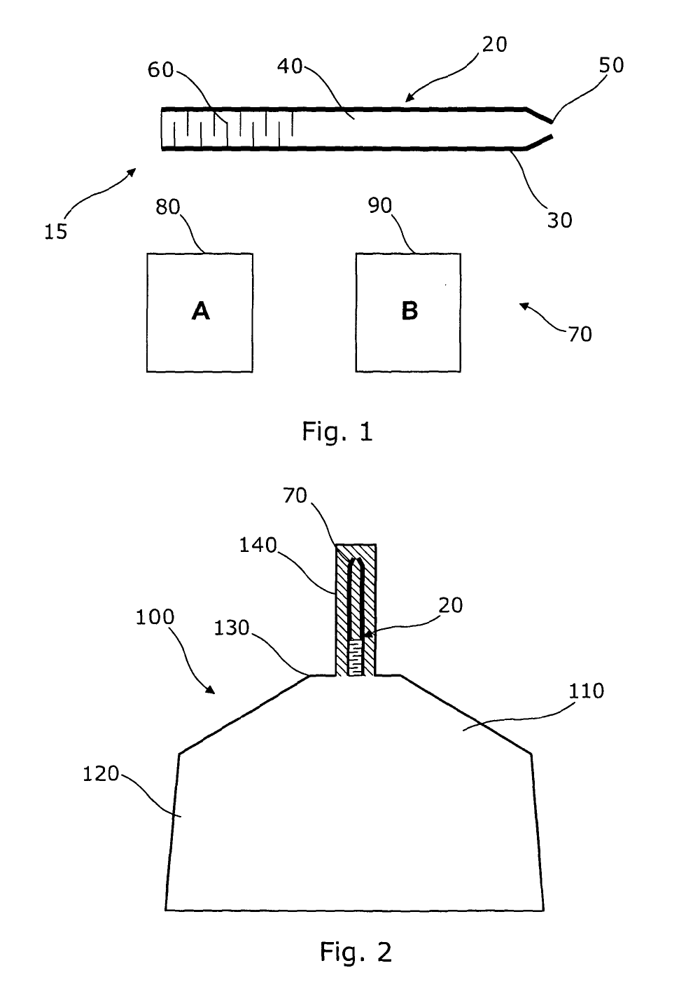

FIG. 1 shows a schematic view of a kit according to the invention; and

FIG. 2 shows a secured rock anchor according to the invention;

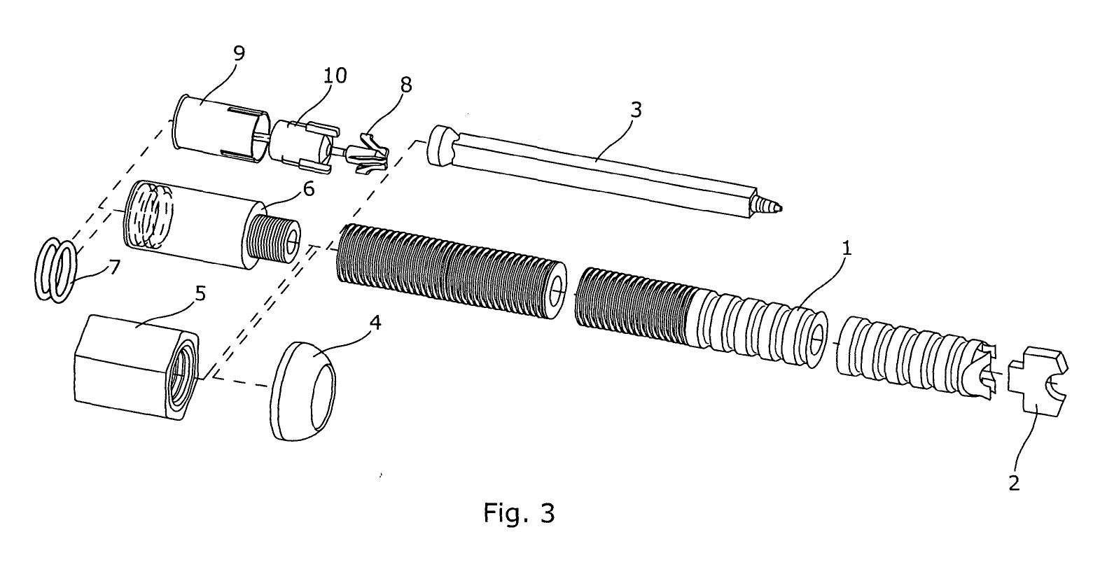

FIG. 3 shows an alternative embodiment of a rock anchor for use in the invention; and

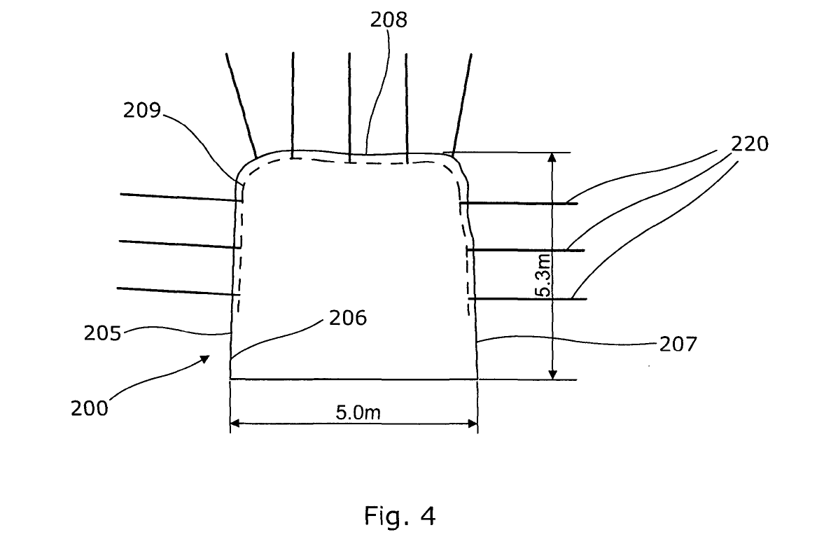

FIG. 4 shows an alternative embodiment of a secured rock anchor according to the invention.

FIG. 1 shows a kit 15 according to the invention. The kit 15 comprises a rock anchor indicated generally at 20 and a two part resin system indicated generally at 70.

The rock anchor 20 is in the form of a rock bolt having a tubular section 30 tapering at its distal end 50 to form an outlet. The rock anchor 20 has an internal passage 40 in which is placed a static mixer at the end opposite to the distal end 50.

The two part resin system 70 contains a first isocyanate part 80 and a second silicate part 90.

In an alternative embodiment, the rock anchor may have an injection, sealing, valving and passageway system such as that disclosed in patent application WO 2010/031132, the contents of which document are incorporated herein by reference in their entirety. In particular, the rock anchor may have such a system as shown in FIG. 1, FIGS. 2-6, FIGS. 7 and 8, FIGS. 9 and 10 or in FIGS. 11-17 of WO 2010/031132 and as described therein.

FIG. 2 shows a secured rock anchor 100 according to the invention. FIG. 2 shows a tunnel 110 formed by rock walls 120 and tunnel roof 130. A drilled hole 140 is shown in tunnel roof 130 in which rock anchor 20 depicted in FIG. 1 has been secured by cured two part resin system 70.

The method for securing a rock anchor 20 in a ground formation such as a tunnel/mine roof 130 is as follows. After the ground formation has been prepared, for example by excavating the tunnel, a hole is drilled in the tunnel roof to form a drilled hole 140. The rock anchor 20 is then inserted into the drilled hole 140 and then the two part resin system 70 is pumped through the rock anchor 20 so that the static mixer 60 causes intimate mixing of the first isocyanate part 80 and the second silicate part 90. The two part resin system 70 then cures to secure the rock anchor in place to stabilise the tunnel roof 130.

In an alternative embodiment the rock anchor may have a mechanical shell to allow pre tension of the bolt followed by injection of the resin system for encapsulation of the bolt.

In an alternative embodiment, the rock anchor 20 could be used to secure a wall of the tunnel 110. Alternatively, the rock anchor 20 could be used to secure a soil or rock formation at a different location, for example in a steep bank.

FIG. 3 shows an alternative embodiment of a rock anchor 10. Rock anchor 10 has a hollow bolt 1 having a rock piercing drill bit 2 mounted at its distal end. At the proximal end, there is provided an injection, sealing, valving, passageway system such as that disclosed in WO 2010/031132. Passageway system 4,5,6 houses valving system 8,9,10. Sealing elements 7 are provided at the proximal end of proximal passageway part 6. Static mixer 3 is provided at the distal end of distal passageway part 4.

FIG. 4 shows a secured mine tunnel 200. The mine tunnel has a width of 5.0 m and a height of 5.3 m. It is in a ground formation 205 which has been secured on each of the vertical walls 206,207 by three rock anchors 220. The roof 208 has been secured by five rock anchors 220. A metal wire mesh netting 209 has been provided to further secure the mine tunnel 200.

In tests, it has been found that where the two part resin system 70 is Carbothix, the punch shear is 75% greater after 6 minutes than that obtained by using a non-pumpable polyester resin version. After 10 minutes, the punch shear is 100% greater. Carbothix was found to have a mean maximum exothermic temperature on mixing of 97° C. over a curing time of about 4 minutes, meeting the requirements of MDG 3006 MRT 8 (Draft, January 2007) Section 5.1 a) for maximum exothermic temperature. It was also found to meet the MDG 3006 MRT 8 (Draft, January 2007) Section 5.1 b), c), d), e) and f) requirements for electrical resistance, fire resistance (after being exposed to a burner flame for 60 seconds, the persistence of a flame on a sample of Carbothix was at most 2 seconds showing a low flammability), fire propagation, flash point (in tests, it was not possible to determine the flash point as it was above 100° C.) and chemical characterisation of resin components, respectively.

The properties of a two part resin system 70 using Carbothix® were compared with those for Minova Australia Pty Ltd product, Geoflex®. The results obtained are shown in Table 1 below from which it can be seen that Carbothix® exhibited greater punch shear and flexural strength at all times post curing.

TABLE 1

| | | | | Punch | | Punch | | Punch |
|---|---|---|---|---|---|---|---|---|
| | | Gel | Flexural | Shears | Flexural | Shears | Flexural | shears |
| | Ratio | time | 15 min | 15 Min | 1 hour | 1 hour | 24 hours | 24 hrs |
| Geoflex | 1:1 | 85″ | 0.6 MPa | 9.50 MPa | 3 MPa | 13.6 MPa | 9.25 MPa | 17.65 MPa |
| Carbothix | 1:2 | 55″ | 4.52 MPa | 24.52 MPa | 13.6 MPa | 26.12 MPa | 16.23 MPa | 29.93 MPa |

1-17. (canceled)

18. A kit comprising a rock anchor having a static mixer and a two part resin system, wherein a first part of the resin system comprises an isocyanate prepolymer and a second part of the resin system comprises a silicate.

19. The kit of claim 18, wherein the two part resin system has a volume ratio of silicate to isocyanate prepolymer ranging from 1:1 to 1:3.

20. The kit of claim 18, wherein the two part resin system has a viscosity ranging from 200-400 cps.

21. The kit of claim 20, wherein the two part resin system does not comprise a particulate filler.

22. The kit of claim 21, wherein the two part resin system has a volume ratio of silicate to isocyanate prepolymer of 1:2.

23. The kit of claim 18, wherein the static mixer comprises at least 10 elements.

24. The kit of claim 18, wherein the rock anchor is a self drilling bolt.

25. A rock anchor comprising:
an internal channel in which is mounted a static mixer; and
a resin in the internal channel, wherein the resin is formed by curing a two part resin system comprising an isocyanate prepolymer first part and a silicate second part.

26. A method of securing a rock anchor in a drilled hole in a ground formation, comprising:
providing a rock anchor having an internal channel in which is mounted a static mixer;
inserting the rock anchor in a drilled hole; and
injecting a two part resin system through the internal channel of the rock anchor and into the drilled hole to mix the two part resin system in the static mixer and cure the two part resin system in the drilled hole and internal channel such that the rock anchor is secured in the drilled hole;
wherein a first part of the resin system comprises an isocyanate prepolymer and a second part of the resin system comprises a silicate.

27. The method of claim 26, wherein the two part resin system has a volume ratio of silicate to isocyanate prepolymer ranging from 1:1 to 1:3.

28. The method of claim 26, wherein the two part resin system has a viscosity ranging from 200-400 cps.

29. The method of claim 28, wherein the two part resin system does not comprise a particulate filler.

30. The method of claim 29, wherein the two part resin system has a volume ratio of silicate to isocyanate prepolymer of 1:2.

31. The method of claim 26, wherein the static mixer comprises at least 10 elements.

32. The method of claim 26, wherein the rock anchor is a self drilling bolt.

33. The method of claim 26, wherein the ground formation is a mass of rock, earth, and/or soil.

34. The method of claim 26, wherein the ground formation is located in an embankment, quarry, mine, or tunnel.
